(19) United States
(12) Patent Application Publication
(10) Pub. No.: US 2018/0127215 A1
(43) Pub. Date: May 10, 2018

(54) CONTINUOUS CONVEYOR

(71) Applicant: Axmann Foerdersysteme GmbH, Zwenkau (DE)

(72) Inventor: Norbert AXMANN, Sinsheim (DE)

(73) Assignee: Axmann Foerdersysteme GmbH, Zwenkau (DE)

(21) Appl. No.: 15/390,808

(22) Filed: Dec. 27, 2016

(30) Foreign Application Priority Data
Nov. 8, 2016 (DE) 10 2016 121 349.7

(51) Int. Cl. B65G 23/18; B65G 17/34

(52) U.S. Cl. CPC B65G 23/18; B65G 17/345

(57) ABSTRACT

A continuous conveyor is used as a sorting apparatus, for example, and includes a drive element that is guided over at least two drums and pulls a plurality of carriages. Entrainment of the carriages is implemented using permanent magnets, which are preferably disposed on the drive element, and the pulling force of which is transferred to the carriages using drivers affixed to them.

### CROSS REFERENCE TO RELATED APPLICATIONS

Applicant claims priority under 35 U.S.C. § 119 of German Application No. 10 2016 121 349.7 filed Nov. 8, 2016, the disclosure of which is incorporated by reference.

### BACKGROUND OF THE INVENTION

### 1. Field of the Invention

The present invention relates to a continuous conveyor, comprising a drive element that circulates over at least two drums, as well as a plurality of carriages pulled by a tension belt side of the drive element.

### 2. Description of the Related Art

A plurality of conveying apparatuses with and without sorting devices has become known. Such devices frequently form a circulating, endless system. In this regard, chains or V-belts are predominantly used as endless conveying means. Such apparatuses have become known, for example, from DE 198 01 706 A and from DE 100 13 332 A.

A significant characteristic of combined conveying and sorting devices is that an unloading function is added to the conveying function. In other words, distribution of the piece goods to be sorted, to the desired target locations, takes place, wherein the unloading mechanism circulates with the conveying means. Such sorting systems can be broken down into tilt tray sorters, cross-belt sorters, and sliding shoe sorters.

A transport and sorting apparatus of the type stated initially has become known from DE 29 05 313 C2. In this apparatus, conveying carriages that follow one another are driven by means of multiple friction wheels. The friction wheels transfer their rotational movement, by way of friction engagement, to a drive belt that is disposed to circulate along the conveying segment and is connected with the conveying carriages. In this regard, the belt is passed through a groove on every conveying carriage, where it is attached to the conveying carriage by way of force engagement, using an attachment bolt.

The flexible drive belt must be guided along its entire circulation path using a plurality of vertical guide rollers, disposed in pairs, in order to prevent bending of the drive belt and jerky movement of the conveying carriages, particularly in the case of tight radii of curvature.

This design is complicated and leads to increased wear in connection with a noise level that is still comparatively high, and therefore it has not found use in practice.

The use of clamping profiles along the longitudinal expanse of such a conveying device, in which the drive belt is clamped in place between two clamping jaws, already leads to a first improvement with regard to a low-wear and quieter design and is disclosed in DE 102 27 998 A1.

### SUMMARY OF THE INVENTION

Proceeding from this background, it is an object of the present invention to provide a continuous conveyor that allows both low-wear and low-noise operation, in spite of having a simple design.

These and other objects are accomplished, according to the invention, by a continuous conveyor having a drive element that circulates over at least two drums, namely at least one drive drum and one deflection drum, as well as a plurality of carriages pulled by a tension belt side of the drive element. The carriages are mounted on a floor stand on which they can be moved with rollers. The rollers ensure not only mounting of the carriage on the floor stand but also guidance of the same. The drive element is provided, on its outer side facing away from the drums, along its longitudinal expanse, with a plurality of magnetic means of action, for example permanent magnets; the drive element magnetically contacts drivers of the carriage using the drive element, and carries them along as the drive element moves. Magnetic means of action, just like the drivers, can be not only ferromagnetic elements but also permanent magnets, as long as at least one of the elements is structured as a permanent magnet. The permanent magnets, however, can be provided on the drive element, on the carriage, or on both sides in the case of opposite contact surfaces.

By means of the magnetic contacting, practically entirely wear-free entrainment of the carriages by the drive element is made possible. Where the drive element, coming from the deflection drum or the drive drum, impacts the driver of the carriage, magnets and drivers make contact by simple touching, and the entrainment force of the magnets increases with a decreasing distance from and angle of the drive element relative to the carriage and its drivers. Separation of drive element and carriage at the opposite end of the drive segment, where the drive element is once again deflected away from the carriage by way of the second drum, takes place in just as continuous and low-noise manner.

On the basis of this simple but effective design, therefore not only is a manageable design effort required for creation of a continuous conveyor, but also low-noise operation of the conveyor is made possible.

There are different possibilities with regard to attachment of the permanent magnets on the drive element. In general, attachment means are used for attachment of the permanent magnets, which means engage through an installation bore of the permanent magnets and an engagement opening in the drive element and thereby create a mechanical, force-engagement connection between the permanent magnets and the drive element.

The installation bore, in this connection, can be disposed in a recess of the permanent magnet, so that a head of the fastening means can be set back relative to the surface of the permanent magnet or maximally disposed flush with it.

Preferably, the permanent magnets will be produced by means of a screw connection, consisting of a screw and a nut, as well as further washers, if necessary, snap rings, and the like. In this case, the head of the screw will preferably be embedded in the recess and will remain set back behind the surface of the permanent magnet.

Particularly if the drive element is a drive belt, which is passed over drums having a continuous surface, it can be more practical to dispose the nut in the recess of the permanent magnet and to insert a flat-head screw from the inside of the drive belt through the installation bore. The screw then should maximally end flush with the surface of the permanent magnet in order to allow planar contact of the permanent magnet with the drivers of the carriages. If the nut or a larger screw head is supposed to be used on the inside of such a drive belt, it is practical to adapt the surface of the drums to this use. This surface can be formed from a plurality of friction disks that are parallel and spaced apart from one another. The disks keep the space required for the nuts or screw heads clear between them.

In the same manner, rivets and other non-releasable connections between the permanent magnets and the drive element can also be produced in place of the releasable screws, particularly also glued connections, welded connections, and soldered connections.

Permanent magnets consist of a relatively brittle material, and this brittleness makes them susceptible to fractures and other mechanical impairments. In order to avoid these impairments, the permanent magnets can be provided with an impact-resistant sheathing that cushions mechanical forces. Such a sheathing should be produced from a non-magnetic material, in order not to influence the function of the permanent magnets, so that materials such as rubber, or also metals such as aluminum, are particularly suitable for this.

Furthermore, the drive element can have friction strips on its outer side, which strips can be provided at least in certain sections. These friction strips are preferably at least as high as the permanent magnets, but can also be higher than them. In addition to magnetism, a friction engagement can bring about a further transfer of force to the carriages, between the strips and the carriages.

It is true that the friction strips can also be provided only in certain sections. Nevertheless, it certainly appears advantageous if the strips are configured to be completely circumferential and thereby bring about an additional continuous transfer of force on the basis of their friction engagement with the bottom of the carriages.

A particularly preferred embodiment of the drive element provides that alternating rows of one or more friction strips and one or more rows of permanent magnets are formed on the surface of the drive element, in order to guarantee transfer of force that covers the entire area.

Instead of affixing friction strips between the permanent magnets, these can also be embedded in depressions provided for this purpose, which preferably replicate the shape of the permanent magnets and accommodate them with shape engagement or with play.

In principle, all types of circulating strands that can withstand stress, particularly drive belts, are suitable as drive elements. Such a drive belt can furthermore be reinforced with steel wire, in order to transfer greater force and to make the drive belt more robust. Likewise, drive chains, hinged belts composed of steel or plastic, plastic link belts or V-belts are particularly suitable for use according to the invention. Then, bores and tabs for attaching the magnets are provided on these drive elements, as well. Drive elements of this type can transfer higher tension forces, also for transport of sheet-metal containers, steel frames and the like.

Depending on the type of continuous conveyor that is used, the drivers can be configured very differently. For example, when using carriages, the driver can be formed as a bottom sheet, which can be attracted and held by the permanent magnets. In particular, such solutions are suitable for cross-belt sorters, which have such a defined bottom.

Alternatively, the continuous conveyor can also be structured as a bulk material conveyor, having a conveyor belt with a layer of steel elements or steel cables set into it. In a special case of the steel-belt conveyor, the conveyor belt itself is produced from steel and in turn is ferromagnetic. In this way, the permanent magnets, which are attached to the drive element in this case, can enter into direct force engagement with the conveyor belt.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows in a top view, a continuous conveyor having a sorting segment that is closed in itself, which runs in a horizontal plane and possesses two straight sections, in each instance, and semi-circular arc-shaped sections at their ends, which connect the ends of the straight sections with one another;

FIG. 2 is a cross-section through the continuous conveyor, corresponding to the section line II-II in FIG. 1, wherein a cross-belt sorter is used as a carriage and a drive belt having permanent magnets is used as a drive element;

FIG. 3 shows in a view according to Arrow III in FIG. 2, carriages coupled with one another in articulated manner, by means of a link chain, as well as a magnetic belt drive having permanent magnets that engage on the carriages on the underside;

FIG. 4 is a lateral top view from the perspective of the opposite side relating to FIG. 2;

FIG. 5 is a top view of the drive belt deflected by way of a deflection drum, having permanent magnets and friction strips;

FIG. 6 is a lateral cross-sectional view of the drive belt according to FIG. 5 through a row of permanent magnets;

FIG. 7 is a detail top view of a drive belt with square permanent magnets in an offset arrangement;

FIG. 8 is a lateral cross-sectional view of a permanent magnet screwed onto the drive belt;

FIG. 9 shows a variant of FIG. 8, in which an impact-resistant sheathing has been added to the permanent magnet;

FIG. 10 shows a further variant of FIG. 8, in which the permanent magnet is embedded in a belt depression;

FIG. 11 shows a variant of FIG. 2, showing a bulk material conveyor in a cross-sectional representation;

FIG. 12 shows in a detail side view, guidance of carriages coupled with one another, in different planes;

FIG. 13 shows in a top view of a continuous conveyor, a sorting segment having a segment progression that deviates from FIG. 1; and

FIG. 14 shows in a cross-sectional view, a chain link of a multi-strand roller chain having permanent magnets attached at the side, as an alternative drive element.

### DETAILED DESCRIPTION OF PREFERRED EMBODIMENTS

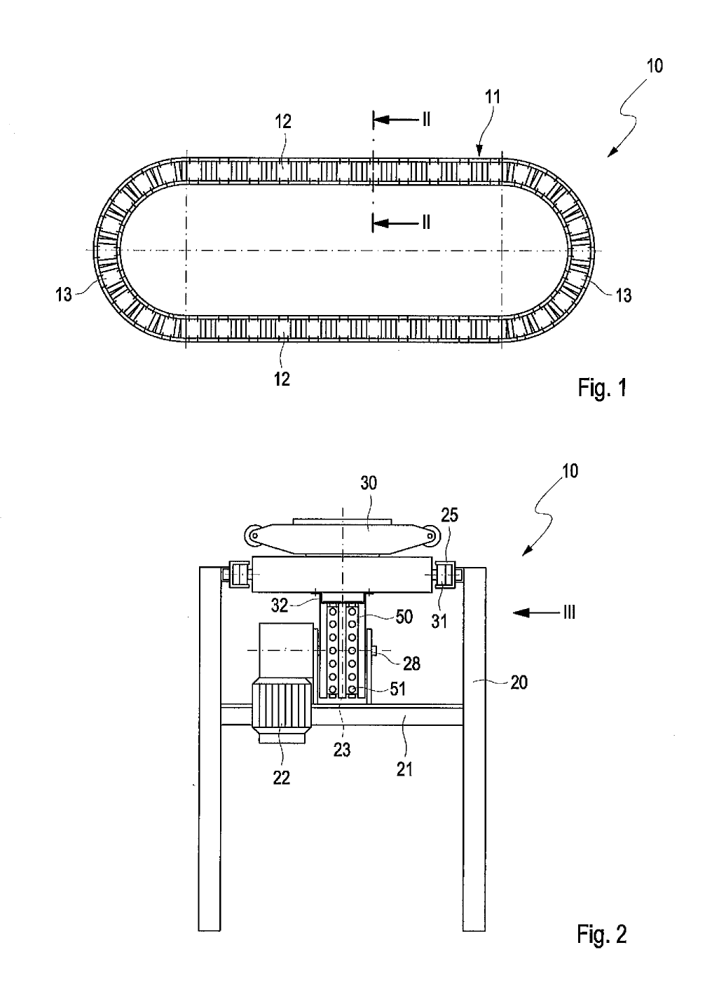

The continuous conveyor 10 illustrated in FIGS. 1 to 3 possesses a sorting segment 11, which is closed in itself, runs in a horizontal plane, and has two straight-line sorting sections 12 as well as two arc-shaped sorting sections 13 that connect the straight-line sorting sections 12 with one another. At least one loading station and, consecutively, multiple ejection stations with lateral ejection chutes are disposed along the sorting segment 11. The loading station and the ejection stations having the said ejection chutes are not illustrated in the drawing.

The constant conveyor 10 furthermore comprises, as a drive element, a drive belt 50 having a plurality of permanent magnets 51 disposed on it, which magnets can pull the carriage shown in FIG. 2, in the form of a cross-belt sorter 30, on a driver in the form of a bottom sheet 32. By means of rotation of the drive drum 23, the drive belt 50 is pulled forward as the result of friction engagement between parallel friction disks that form the drive drum 23, and the inside of the drive belt 50. The permanent magnets 51 situated on the outside of the drive belt 50 enter into contact with a driver, here a bottom sheet 32, in this connection, and pull this sheet along with them, thereby putting the cross-belt sorter 30 into motion.

Each of the cross-belt sorters 30 possesses two rollers 31 that are spaced apart from one another on both sides in the conveying direction, in each instance, which rollers are guided on running rails 25, fixed in place on the apparatus and at a lateral distance from one another, in a manner that is not of further interest here, in detail. On the cross-belt sorter 30, a belt band that can be driven transverse to the sorting segment 11 is disposed, in each instance. The belt bands of the cross-belt sorter 30 are guided by way of deflection rolls, in each instance, which rolls have an axis of rotation that extends in the conveying direction. The transverse drive of the belt bands of the cross-belt sorters 30 takes place by means of drive means that can optionally be brought into interaction in the ejection stations; their composition and function is also of no further interest here.

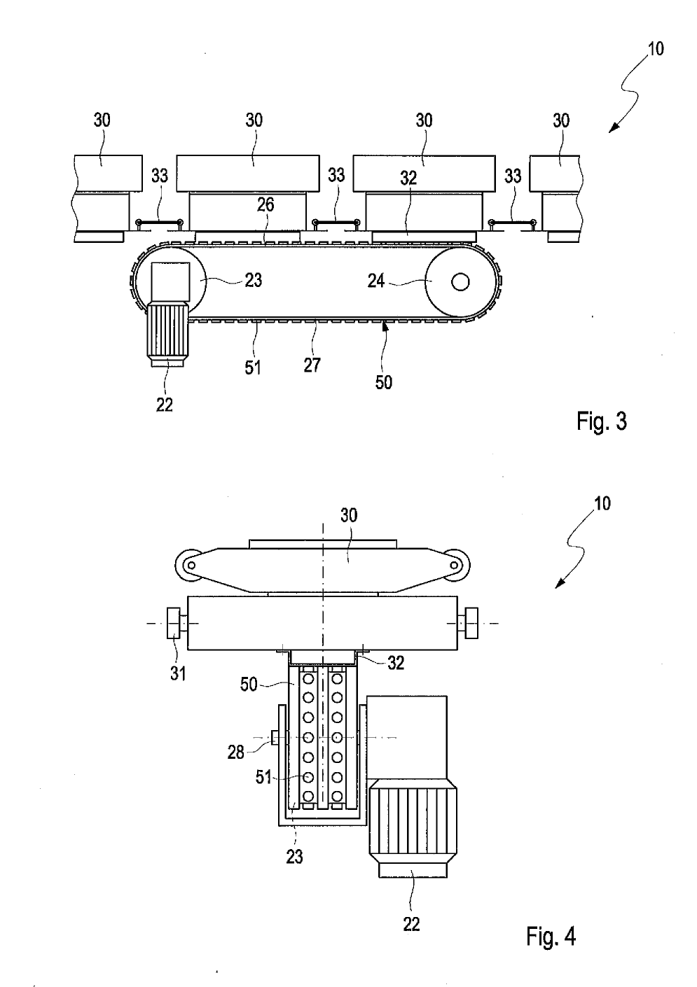

As shown in FIG. 3, the cross-belt sorters 30 that are guided to be movable consecutively along the sorting segment 11 are coupled with one another by way of articulated couplings 33, so that the cross-belt sorters 30 can thereby pass through sections 12, 13 of the sorting segment 11 shown in FIG. 1, which sections are configured to be straight-line and arc-shaped, but furthermore can be transferred to sorting sections that are elevated or lowered. For each section of the sorting segment 11, in each instance, a carriage is situated in the region of the drive belt 50, the tension belt side 26 of which, with the permanent magnets 51 attached to it, stands in engagement with the drivers of the cross-belt sorters 30. The empty belt side 27 is guided back on the underside, at a distance from the cross-belt sorters 30. A deflection drum 24 ensures the required tension of the drive belt 50 and the required friction engagement for transferring the force of the drive 22 to the drive belt 50 by way of the drive drum 23.

FIG. 4 shows, in greater detail, a cross-belt sorter 30 set onto the drive belt 50, which sorter has a bottom sheet 32 with which it lies on the permanent magnets 51 of the drive belt 50. A drive 22 mounted on transverse support 21 of floor stand 20 (see FIG. 2) drives the drive drum 23, which cannot be seen here, but over which drum the drive belt 50 is stretched, by way of a drive axle 28.

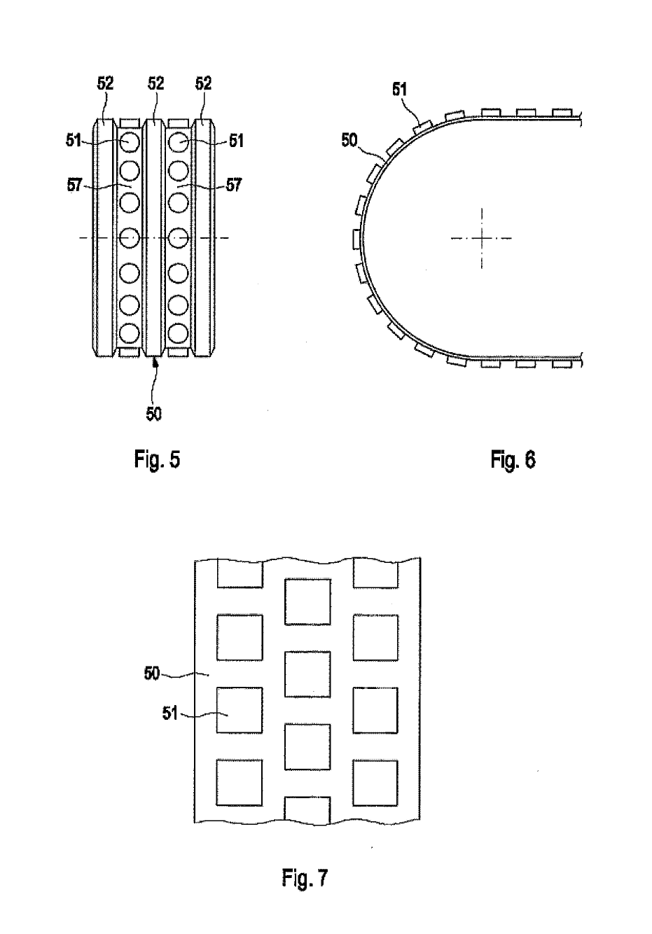

A plurality of friction strips 52, which are shown in FIG. 5, ensures better protection on the drive belt 50, in detail. These strips are disposed, in the present concrete example, centered and on both edges of the drive belt 50, on its outer side, and connected with the drive belt 50 there by means of gluing or welding. The permanent magnets 51 are disposed in rows between the protective or friction strips 52, and therefore in a belt depression 57 formed by the friction strips 52, and thereby doubly ensure entrainment of a carriage placed on the drive belt 50. First, entrainment takes place on the basis of the magnetic holding force of the permanent magnets 51, but this entrainment is additionally supported by the friction engagement that forms between the friction strips 52 and the bottom sheet 32. In the region of the drive drum 23 or of the deflection drum 24, the permanent magnets 51 move away from the drivers of the carriages, because of the arc described by the drive belt 50, so that the carriages come out of engagement with the drive belt in simple and noise-free manner. This feature can further be seen in FIG. 6, where the deflection in FIG. 5 is shown from the side, as a cross-section through one of the rows of permanent magnets 51.

FIG. 7 shows an alternative embodiment of the arrangement and shaping of the permanent magnets 51 on a section of the drive belt 50. In the variant shown here, the permanent magnets 51 are rectangular in their basic shape.

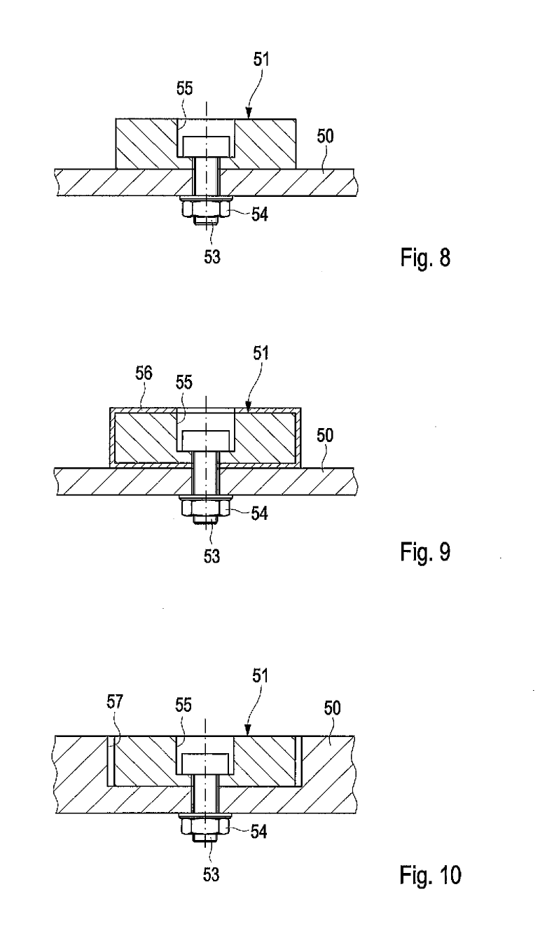

FIGS. 8, 9, and 10 show three variants of a permanent magnet 51 screwed onto the drive belt 50, in a cross-sectional representation. The permanent magnets 51 have a recess 55, for simplified attachment to the drive belt 50, in the center of which recess a bore is disposed, through which bore a screw 53 passes through the permanent magnet 51 and, at the same time, also the drive belt 50, and is secured with nut 54. The recess 55 is so deep that the screw head does not project beyond the surface of the permanent magnet 51 and thereby does not cause interference when contact is made with the carriage.

In FIG. 9, the permanent magnet 51 additionally has an impact-resistant sheathing 56, which can be used to absorb impacts against the brittle material of the permanent magnet 51, so that the durability of the permanent magnet 51 is improved.

Finally, in FIG. 10 it is shown how the permanent magnet 51 according to FIG. 7 is set into a belt depression 57, so that the drive belt 50, which surrounds the permanent magnet 51, can enter into friction engagement with the carriage that lies above it and is not shown in any detail here, while at the same time, the permanent magnet 51 enters into magnetic force engagement with the carriage.

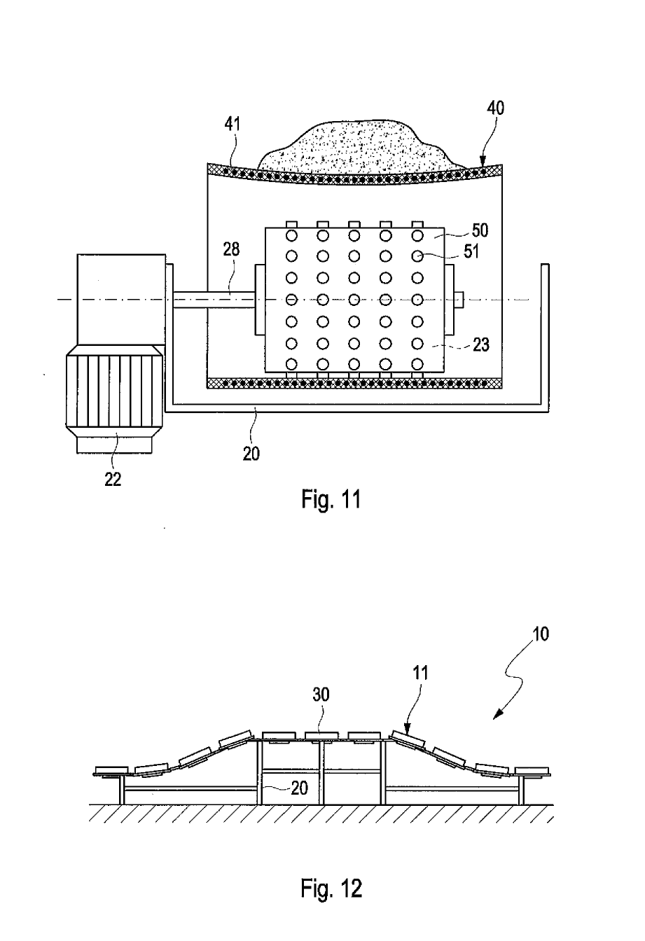

Analogous to FIG. 3, FIG. 11 shows a further embodiment of the invention, which works with a bulk material conveyor 40, however. This conveyor runs at a distance above the drive belt with the material to be sorted. In contrast to the arrangement shown in FIG. 3, in FIG. 11 the tension belt side is the lower part of the drive belt 50, which experiences a transfer of force by the drive 22, by way of the drive axle 28 and the drive drum 23, while the upper part represents the empty belt side. The bulk material conveyor 40, which runs back empty, is in engagement with the permanent magnets on the underside of the drive belt 50, wherein the drivers, in this case, are steel cables 41 embedded in the bulk material conveyor 40.

FIG. 12, in a schematic side view, illustrates a continuous conveyor 10 of the type stated, in which the sorting segment 11 accommodated on the floor stand 20, which is only indicated here, is elevated in certain sections.

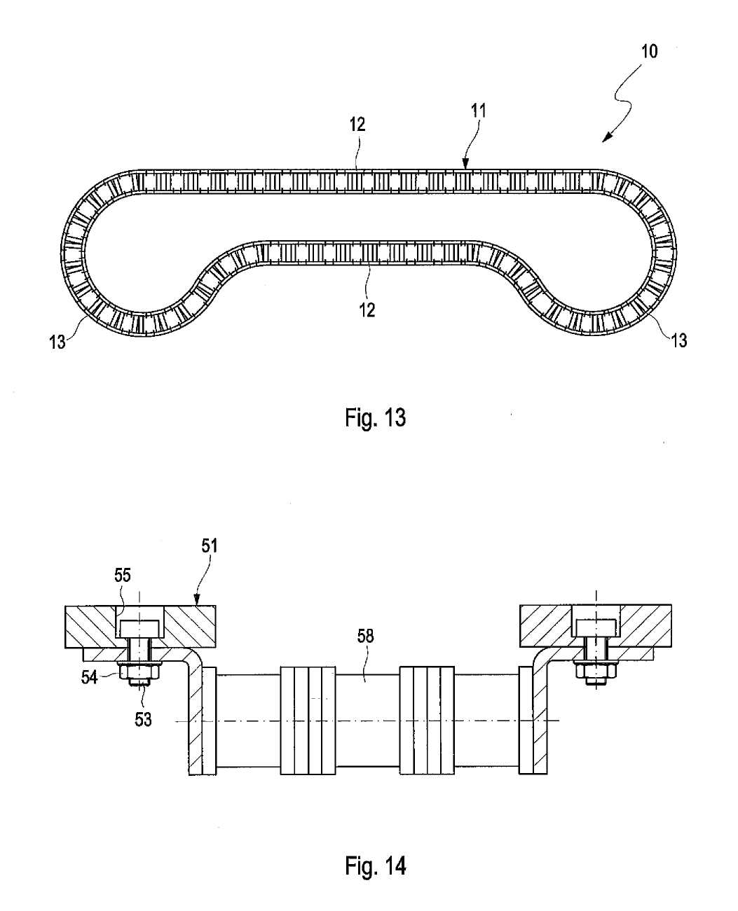

The sorting segment 11 illustrated in FIG. 13 also possesses two straight-line sorting sections 12 that run at a distance from one another, and two arc-shaped sorting sections 13 that connect these straight-line sorting sections 12 with one another, but the arc-shaped sorting sections 13 are configured approximately as a three-quarter circle. The continuous conveyor 10 described, along with semi-circular arrangements, can easily overcome narrow curve arrangements, because the design of the drivers of the individual carriages is not subject to any special geometric requirements.

In a further variant, this invention is also very advantageous for other cases of use. For example, instead of a drive belt, strong drive elements such as drive chains 58, hinged steel belts, plastic link belts, V-belts and the like can also be used. The permanent magnets 51 are then attached to the drive element in similar manner as shown in FIG. 14.

Thus, a continuous conveyor has been described above, the carriages of which are driven by way of a drive element, to which a plurality of magnetic means of action are assigned, and that makes contact, with force engagement, with magnetic counter-means of action, by way of magnetic coupling. This arrangement allows both a simple and effective, low-noise design.

Although only a few embodiments of the present invention have been shown and described, it is to be understood that many changes and modifications may be made thereunto without departing from the spirit and scope of the invention.

What is claimed is:

1. A continuous container comprising:
(a) first and second drums;
(b) a drive element that circulates over the first and second drums, said drive element having a tension belt side and an outer side forcing away from the first and second drums; and
(c) a plurality of carriages pulled by the tension belt side of the drive element, said carriages having a bottom side;
wherein on the outer side, the drive element has longitudinally distributed first magnetic action devices; and
wherein on the bottom side, the carriages have second magnetic action devices that interact with the first magnetic action devices.

2. The continuous conveyor according to claim 1, wherein (a) the first magnetic action devices are permanent magnets and the second magnetic action devices are permanent magnets or are formed from a ferromagnetic driver, or (b) the second magnetic action devices are permanent magnets and the first magnetic action devices are permanent magnets or formed from a ferromagnetic driver.

3. The continuous conveyor according to claim 2, wherein the drive element comprises a drive belt and the permanent magnets have at least one installation bore and are attached to the drive belt using a fastener.

4. The continuous conveyor according to claim 3, wherein the at least one installation bore is disposed in a recess for accommodating a head of the fastener.

5. The continuous conveyor according to claim 3, wherein the permanent magnets are connected with the drive belt by at least one screw connection comprising a screw and a nut.

6. The continuous conveyor according to claim 5, wherein the first and second drums are formed from multiple parallel friction disks, spaced apart from one another, wherein the at least one screw connection of the permanent magnets is disposed in interstices between the friction disks.

7. The continuous conveyor according to claim 2, wherein the permanent magnets are attached to the drive element via a glued connection, a welded connection, or a soldered connection.

8. The continuous conveyor according to claim 2, further comprising an impact-resistant sheathing associated with the permanent magnets.

9. The continuous conveyor according to claim 8, wherein the impact-resistant sheathing is produced from rubber or aluminum.

10. The continuous conveyor according to claim 3, wherein the drive element has friction strips on at least sections of the outer side.

11. The continuous conveyor according to claim 10, wherein the friction strips have at least approximately the same height as the permanent magnets.

12. The continuous conveyor according to claim 10, wherein the friction strips are disposed circumferentially on the drive belt.

13. The continuous conveyor according to claim 12, wherein the friction strips are disposed in strip form in a longitudinal direction of the drive belt, and wherein the permanent magnets are arranged in at least one row between two of the friction strips.

14. The continuous conveyor according to claim 3, wherein the permanent magnets are embedded in depressions on the drive belt.

15. The continuous conveyor according to claim 1, wherein the drive element is a drive belt, a drive chain, a hinged belt, a plastic link belt or a V-belt.

16. The continuous conveyor according to claim 1, wherein the drive element is a drive belt reinforced with steel wire.

17. The continuous conveyor according to claim 1, wherein the second magnetic action devices of the carriages are configured as a bottom sheet.

18. The continuous conveyor according to claim 1, wherein the continuous conveyor is a steel belt conveyor or a bulk material conveyor having a conveyor belt embedded with steel elements or steel cables.
